(19) United States
(12) Patent Application Publication
(10) Pub. No.: US 2015/0302364 A1
(43) Pub. Date: Oct. 22, 2015

(54) FACILITATING PRESENTATION OF LOCALIZED INFORMATION REGARDING RECYCLING SERVICE ON A MOBILE DEVICE

(71) Applicant: ELECTRONIC RECYCLERS INTERNATIONAL, INC., Fresno, CA (US)

(72) Inventors: Richard E. Calzada, Fresno, CA (US); John S. Shegerian, Fresno, CA (US)

(73) Assignee: ELECTRONIC RECYCLERS INTERNATIONAL, INC., Fresno, CA (US)

(21) Appl. No.: 14/255,841

(22) Filed: Apr. 17, 2014

(51) Int. Cl. G06Q 10/00; G06Q 10/10; G06Q 30/02

(52) U.S. Cl. CPC G06Q 10/30; G06Q 30/0261; G06Q 10/1095

(57) ABSTRACT

A system and method for facilitating presentation of localized recycling information on a mobile device is disclosed. Recycling information regarding recycling service(s) available at corresponding service locations may be managed. Service presentation definitions associated with corresponding geolocations (e.g., municipality) may be managed for presenting one or more recycling services available at the geolocations. Location information indicating a geolocation of interest to a user may be received from a mobile device. Based on the received location information, recycling information regarding recycling service(s) available at the geolocation may be presented on the mobile device in accordance the presentation definition(s) associated with that geolocation. In some examples, the user may be enabled to interact with the localized recycling information presented on the mobile device, such as setting a reminder, offering an item for recycling, calculating carbon prints and/or any other interactions.

### FIELD OF THE DISCLOSURE

This disclosure relates to facilitating presentation, on a mobile device, of localized information regarding recycling services available at corresponding locations, the localized information being presented on the mobile device in accordance with service presentation definitions associated with the locations.

### BACKGROUND

Waste disposal is an integral part of every household. Typically, at a given location where a household resides, one or more waste collection and recycling services are available. For example, at the given location, trash collection service may be provided by the municipality, electronic waste (e-waste) collection and recycling services may be provided by electronic retail stores and/or e-waste collection facilities, waste dump sites (e.g., sites for dumping furniture, scrap metal, etc.) may be commercially operated by individual operators, chemical wastes (e.g., motor oils) may be handled by specialized service sites, and so on. A user may desire to acquire information regarding the recycling services available at the given location. For example, information such as pickup dates, contact information, accepted materials, available offers, reward programs, incentives, and any other information regarding the recycling service(s) available near the given location may be of particular interest to the user.

### SUMMARY

One aspect of the disclosure relates to facilitating localized information regarding one or more recycling services available near a location provided by a user via mobile device. Upon receiving location information indicating a user's location (e.g., a real-world address) corresponding to a geographic location (e.g., a city the real-world address is within) from the mobile device associated with the user, localized recycling information regarding recycling service(s) available at that geographic location may be retrieved and presented on the mobile device. The localized recycling information may be presented on the mobile device in accordance with one or more service presentation definitions defining presentation of the recycling information for that geographic location. This may create, on the mobile device, look-and-feel identifying recycling service(s) available at the geographical location. This may enhance user experience in acquiring localized information regarding recycling service(s) available at the geographic location.

As used herein, “waste” is referred to as material that has been discarded or is no longer wanted by entities associated therewith, or that, for any other reason, enters waste collection, recovery, treatment, processing, or recycling processing systems, facilities or processes.

As used here, “recycling” is referred to as separating, dismantling or processing materials, components or commodities in waste for the purpose of preparing the materials, components, or commodities for use or reuse in new products or components thereof. Recycling includes the manual and mechanical separation of the waste to recover materials, components or commodities contained therein for the purpose of reuse or recycling, and changing the physical or chemical composition of the waste to segregate components for the purpose of recycling those components.

As used herein, “recycle service provider” is referred to as a provider that provides recycling services for recycling waste. A recycle service provider may include an entity that operates one or more recycling facilities, an entity that receives electronic waste (for example, for organizing, categorizing or consolidating the electronic waste before the electronic waste is transported to a recycling facility), an entity that accepts waste from consumers and stores before transporting the waste to a recycling facility or a recycling consolidation entity, and/or any other entity that may provide recycling services. Examples of a recycle service provider may include municipalities, solid waste companies, electronic waste collection stations, stores that collect used products from customers for recycling, waste dump sites (e.g., sites for disposing automobiles, furniture), special handling facilities, and any other types of recycle service providers.

As used herein, a “user” is referred to as an entity that dispose waste, including but not limited to an individual, a business, corporation, limited partnership, not-for-profit corporation, a public corporation, public school, school district, private or parochial school or board of cooperative educational services or governmental entity, an entity involved in a wholesale transaction between a distributor and retailer, and/or any other types of users.

The user component may be configured to manage user information associated with individual users. The user information managed by the user component may include information identifying the individual users, recycling information regarding materials recycled by the given user, recycling activities engaged in by the given user, specific recycling service providers employed by the given user, and/or any other user information. For example, the user information managed by the user component may include information indicating a date and time of a collection service received by the given user, a location where the collection service was provided, material(s) was accepted during the collection service, and/or any other types of information regarding one or more recycling and/or disposal activities engaged by the given user in the past.

The recycling service information component may be configured to manage recycling information regarding recycling services provided by recycling service providers at corresponding service locations. Examples of recycling services indicated by the recycling information managed by the recycling service information component may include household waste collection, recycling and disposal service, e-waste collection and recycling service, automotive disposal, construction materials disposal, metal and glasses disposal, buy-back service, special item handling services (e.g., chemical waste, medical waste), and any other types of recycling services. The information regarding a given recycling service available at a given service location as managed by the recycling service information component may include information identifying the recycling service provider(s) providing the given recycling service, location information indicating where the given recycling service is provided, collection information indicating, for example, pickup date and time of the given recycling service, upcoming events associated with the given recycling service, material accepted by the given recycling service, service location(s), reward programs, incentive information associated with the given recycling service, drop-off sites, contact information of the given recycling service provider, and/or any other recycling information regarding the given recycling service.

The service presentation definition component may be configured to manage service presentation definitions for presenting recycling information regarding recycling services available at geographic locations on mobile devices. The service presentation definitions managed by the service presentation definition component may be differentiated from one geolocation to another. In some instances, the service presentation definitions may be further differentiated based on different service providers near a given geolocation. A set of service presentation definitions may define the visual appearance of a graphical user interface within which recycling information regarding the corresponding recycling services may be presented on mobile devices associated with users. The definitions may include an arrangement for presenting the information regarding a given recycling service within the graphical user interface, one or more of colors associated with the graphical user interface, one or more font types/styles of the graphical user interface, one or more images, one or more videos, specifications for frame characteristics of the graphical user interface, and/or any other definitions defining the visual appearance of the graphical user interface within which the recycling information regarding recycling services is presented. In some instances, the definitions may include presentation style. In implementations, a set of presentation definitions associated with a given geolocation may be transmitted to a mobile device along with the recycling information regarding recycling service(s) available at the given geolocation.

In some examples, the service presentation definitions may define an audio presentation of recycling information on a mobile device associated with the user. In those examples, the service presentation definitions may be associated with a geolocation and may include audio presentation definitions for presenting, in audio, the recycling information regarding one or more recycling services available at the associated geolocation in audio. Such audio presentation definitions may define voice style, tone, language, accent, levels and content of access menus, greeting style, speech pattern, and any other audio presentation definitions for presenting the recycling information in audio on the mobile device.

The device communication component may be configured to facilitate communications with individual mobile devices associated with users. Operations by device communication component may involve receiving communication requests from the individual mobile devices, transmitting information such as recycling information and service presentation definition information to the individual mobile devices for presentation, receiving user inputs, and/or any other operation for facilitating communications with individual mobile devices. In implementations, the communications facilitated by device communication component may include textual, video, audio, image, multimedia, and/or any other types of communication.

The presentation component may be configured to effectuate presentation of recycling information on the mobile device regarding one or more recycling services available at a given geolocation in accordance with a set of one or more service presentation definitions associated with the given geolocation as managed by the service presentation definition component. To achieve this, the presentation component may be configured to retrieve the recycling information and the associated service presentation definitions based on recycling service available at the user location.

In some examples, the processor may optionally comprise a notification component configured to receive, from a mobile device, information for setting a reminder that reminds the user to receive recycling services on a set of one or more dates, and to effectuate the reminder on the mobile device on the set of the one or more dates. In some examples, the notification component may be configured to generate notifications for presentation on mobile device notifying the user about updates in recycling service information regarding the recycling service(s) available at the user location.

In some examples, the processor may optionally comprise a recycling location component configured to retrieve one or more recycling locations near a user location. For example, one or more drop-off sites may be retrieved by the recycling location component based on the user location.

In some examples, the processor may optionally comprise an offer component configured to facilitate a user associated with a mobile device to offer, via the mobile device, an item in exchange for consideration from a recycling service provider selected by the user. In some examples, the offer component may be configured to facilitate the presentation of offers provided by the recycling service provider to the user on a mobile device. In some examples, the offer component may be configured to present offers for users to purchase from the recycling service provider a container through which the user can mail one or more materials to be recycled to the provider.

In some examples, the processor may optionally comprise a drop-off confirmation component configured to receive, from a mobile device, drop-off information indicating that one or more materials to be recycled has been dropped off at a recycling location by the user associated with the mobile device, transmit the received drop-off information to a computing platform associated with the recycling location for confirmation, receive from the computing platform associated with the recycling location information confirming the receipt of drop-off information; and effectuate presentation of a confirmation of the drop-off information on the mobile device.

In some examples, the processor may optionally comprise a carbon footprint calculation component to calculate the carbon footprint by a user based on materials that have been recycled by the user.

These and other features, and characteristics of the present technology, as well as the methods of operation and functions of the related elements of the structure and the combination of parts, and economies of manufacture will become more apparent upon consideration of the following description and the appended claims with reference to the accompanying drawings, all of which form a part of this specification, wherein like reference numerals designate corresponding parts in the various figures. It is to be expressly understood, however, that the drawings are for the purposes of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates an exemplary system configured for facilitating presentation of localized recycling information on a mobile device.

FIG. 2 illustrates one example of user information managed by the system shown in FIG. 1.

FIG. 3 illustrates one example of recycling service information managed by the system shown in FIG. 1.

FIG. 4 illustrates one example of receiving location information from a mobile device associated with a user to determine a set of one or more recycling services are available at a location indicated by the received location information.

FIG. 5 illustrates one example of presenting on a mobile device one or more recycling services available at a location on the mobile device.

FIG. 6 illustrates one example of presenting on a mobile device recycling information regarding a given recycling service available at a given location in accordance with associated service presentation definitions.

FIG. 7 illustrates one example of presenting on a mobile device information regarding pickup date and time of a given recycling service.

FIG. 8 illustrates one example of presenting on a mobile device information regarding upcoming events related to a recycling service available at a given geolocation.

FIG. 9 illustrates one example of presenting on a mobile device recycling locations near user location.

FIG. 10 illustrates one example of presenting on a mobile device an interface enabling a user associated with the mobile device to offer items in exchange for consideration from a recycling service provider.

FIG. 11 illustrates one example of presenting on a mobile an interface enabling a user associated with the mobile device to buy a container for recycling an item.

FIG. 12 illustrates an exemplary method for facilitating presentation of localized information on a mobile device in accordance with the disclosure.

### DETAILED DESCRIPTION

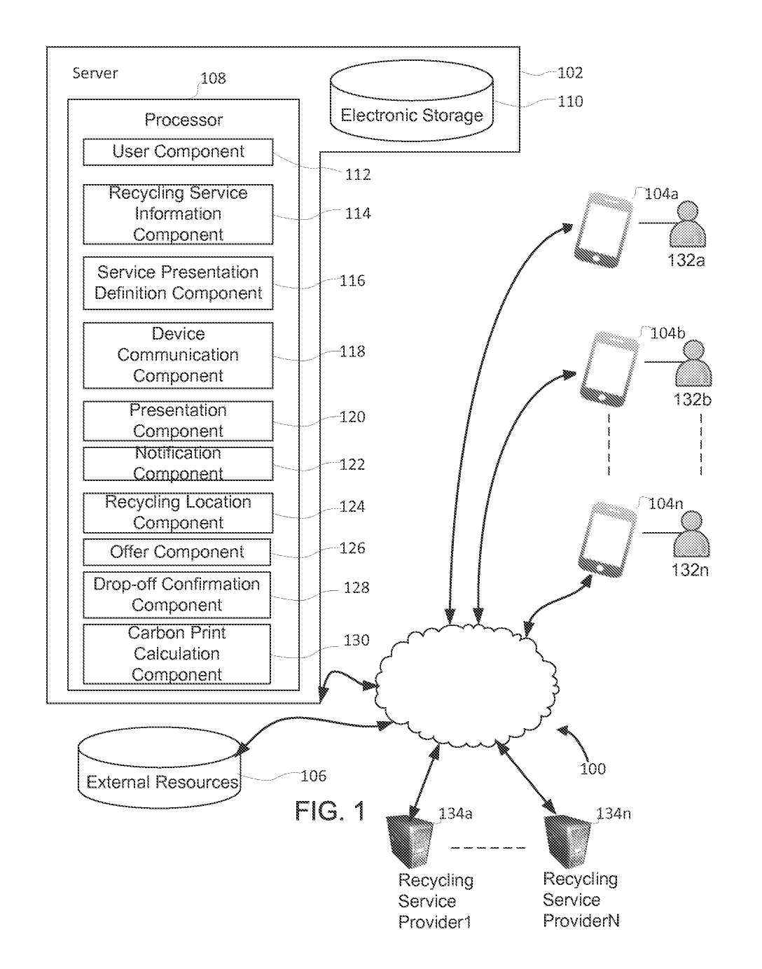

FIG. 1 illustrates an exemplary system 100 configured for facilitating presentation of localized information regarding recycling services on a mobile device. As illustrated in FIG. 1, the system 100 may include a server 102 configured to communicate with mobile devices 104 associated with users 132 according to a client/server architecture via any suitable wired and/or wireless communication channels. In this example, as shown in FIG. 1, the server 102 comprises a processor 108 configured to execute computer components. The computer components may comprise a user component 112, a recycling service information component 114, a service presentation definition component 116, a device communication component 118, a presentation component 120, a notification component 122, a recycling location component 124, an offer component 126, a user mining information component, a carbon print calculation component and any computer components.

The user component 112 may be configured to manage user information associated with individual users of system 100. The user information managed by the user component 112 may include information identifying the individual users, such as name, telephone number, location information and/or any other identifying information. The location information associated with a given user may be received from the given user, for example, via the device communication component 118. As will be discussed in connection with the device communication component 118, the location information associated with the given user may include real-world address information (e.g., unit#, house#, street name, city, state, province and/or zip code) and/or position information (e.g., latitude and longitude information provided by the GPS service on the mobile device 104). It should be understood that the location information associated with the given user, as managed by the user component 112 is not necessarily limited to the location that is of the mobile device 104. The location information associated with the given user may include any location entered by the given user. For example, the location information associated with the given user may include a zip code, even though the mobile device 104 is located outside of the zip code. In some examples, the location information associated with the given user may include position information of the mobile device 104 such that the location information associated with the given user may change dynamically as the mobile device 104 travels from one real-world location to another.

The user information, managed by the user component 112, may include recycling information regarding materials recycled by the given user, recycling activities engaged in by the given user, specific recycling service provider interaction with the given user, and/or any other user information. For example, the user information managed by the user component 112 may include a date and time of a collection service received by the given user, the location of the collection service, the material(s) accepted by the collection service, and/or any other types of information regarding one or more recycling or disposal activities engaged by the given user in the past.

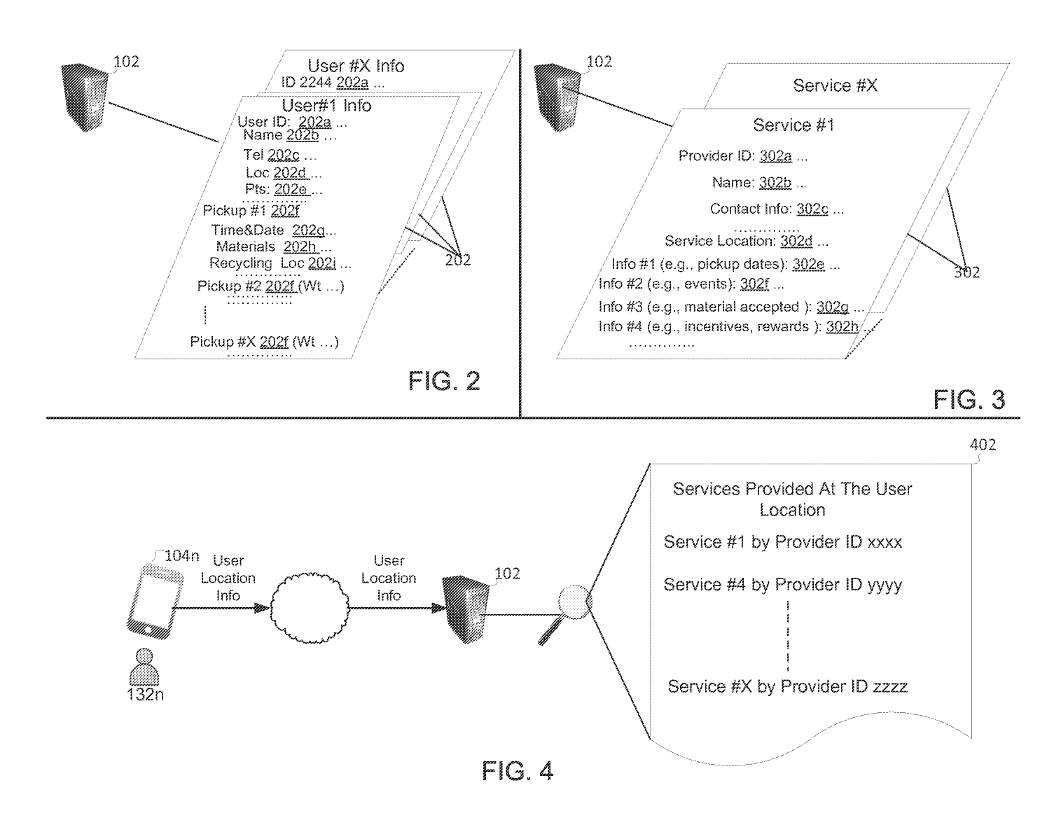

FIG. 2 illustrates one example of user information regarding individual users of system 100. I will be described with reference to FIG. 1. As can be seen from FIG. 2, user information 202 regarding one or more users of the system 100 may be managed. For an individual user, various information regarding the user may be captured and managed by the server 102, e.g., via the user component 112. As shown in this example, such user information may include information indicating User ID 202a of a given user, various contact information (e.g., name information 202b, telephone number information 202c, and location information 202d) associated with the given user. As can also be seen from FIG. 2, the user information 202 may include information indicating one or more recycling services received by the given user (e.g., time and date of the pickup and materials accepted) and/or any other user information. It should be understood that user information 202 shown in FIG. 2 is merely illustrative and not intended to be limiting. User information 202 may include more or less detail in some other examples than those shown in FIG. 2.

Returning to FIG. 1, the recycling service information component 114 may be configured to manage recycling information regarding recycling services provided by recycling service providers at corresponding service locations. Examples of recycling services indicated by the recycling information managed by the recycling service information component 114 may include household waste collection, recycling and disposal service, e-waste collection and recycling service, buy-back service, special item-handling services (e.g., chemical waste, medical waste), automobile disposal, construction material disposal, and any other types of recycling services. Recycling information management by the recycling service information component 114 may involve receiving information from recycling service providers regarding recycling services available at corresponding service locations, adding the information regarding recycling services to electronic storage such as electronic storage 110 shown in FIG. 1, updating the information regarding recycling services at the corresponding location, and/or deleting the information regarding recycling services at the corresponding locations.

Recycling information related to a recycling service available at a given service location as managed by the recycling service information component 114 may include, but not limited to, identifying information identifying the recycling service provider(s) providing the given recycling service, service location information indicating where the given recycling service is provided, collection information indicating, for example, pickup date and time of the given recycling service, upcoming events associated with the given recycling service, material accepted by the given recycling service, reward programs, incentive information associated with the given recycling service, drop-off sites, contact information of the given recycling service provider, tips provided and/or any other recycling service information. It should be understood that the recycling service providers available at a given service location are not limited to commercial operators, but also include non-commercial recycling service providers such as the local municipality (e.g., for trash pickup). In some examples, the recycling information regarding recycling services available at a service location may include information indicating recycling policies, incentives, rewards, drop-off locations, and/or any other general information regarding recycling at the service location.

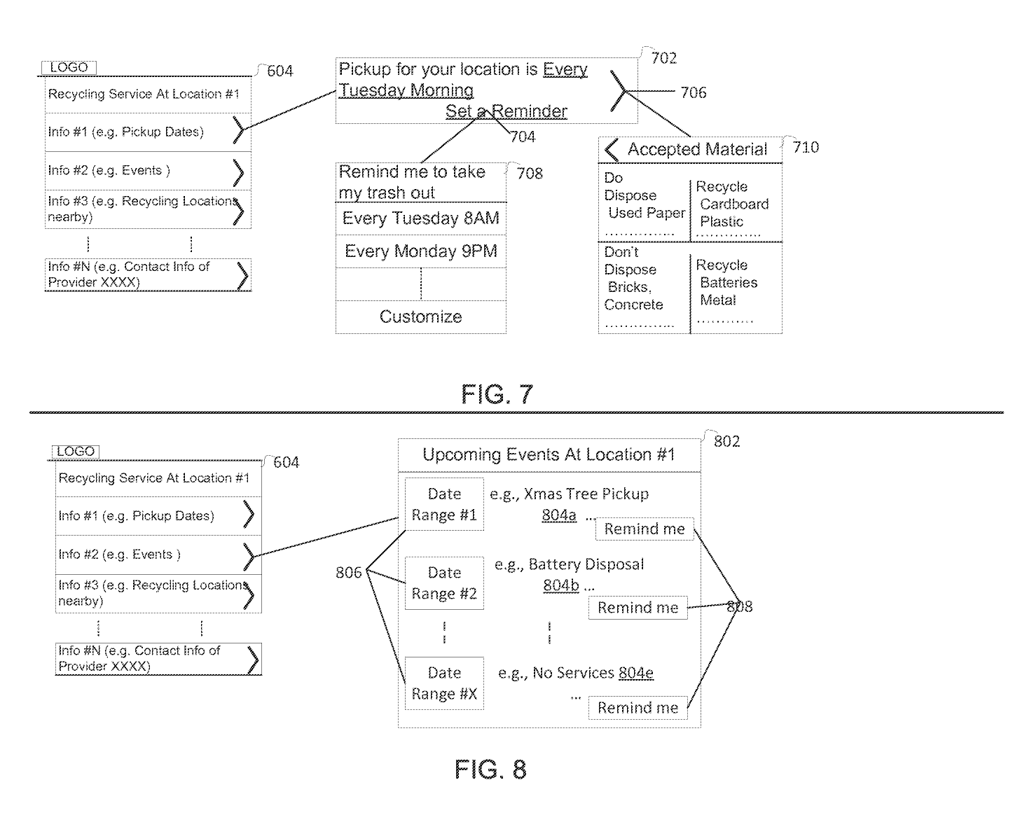

FIG. 3 illustrates one example of recycling service information managed by the recycling service information component 114. As shown in this example, the recycling service information 302 may include the service provider identifying information, which may include an ID 302a, name 304b, contact information 304c (e.g., telephone number, address), and/or any other identifying information associated with the recycling service provider. As also shown, the recycling information 302 may include service location information 302d, which may indicate, for example, one or more zip codes, areas, cities, towns, counties, states, provinces, districts, and/or any other types of service locations where the recycling service is provided. As shown in this example, the recycling service information 302 may include information 302e, which may indicate the pick up date and time of the recycling service at the corresponding service location 302d. (An example of such information is illustrated in FIG. 7). As also shown in this example, the recycling information 302 may include upcoming event information 302e, which may indicate one or more events related to the given recycling services are scheduled to take place at the service location 302d. (An example of such information is illustrated in FIG. 8). As also shown in this example, the recycling service information 302 may include information 302e indicating one or more materials that may be accepted by the recycling service provider at the service location 302d. (FIG. 7 illustrates one example of such information). As also shown in this example, the recycling information 302 may include rewards or incentive information, which may indicate rewards and/or incentives provided by the given recycling service provider. For example, a municipality may encourage residents to recycle paper waste by offering reward points such that for every certain weight of paper waste recycled by a resident, certain amount of points may be awarded to the resident, and the resident may redeem those points for a reward item once his/her point balance breaches a certain threshold. Other examples of reward programs provided by recycling service providers are contemplated. It should be understood the recycling information illustrated in FIG. 3 is not intended to be limiting, nor is it intended to be exhaustive. In some other examples, more or less details may be included in the recycling information 302 managed by the recycling service information component 114. For example, the recycling information may include information indicating one or more tips, guides, help, and/or other useful information to assist a user to recycle.

Returning to FIG. 1, the service presentation definition component 116 may be configured to manage service presentation definitions for presenting recycling information regarding recycling services available at corresponding geolocations on the mobile devices 104. The service presentation definitions managed by the service presentation definition component 116 may be differentiated from one geolocation to another. For example, a first set of service presentation definitions may be associated with a first geolocation and a second set of service presentation definitions may be associated with a second geolocation, which the first set and second set of service presentation definitions may remain separate and discrete from each other. In some examples, the service presentation definitions managed by the service presentation definition component 116 may be further differentiated from one recycling service provider to another. For example, a first recycling service provider may be associated with a first set of service presentation definitions that are different from a second set of service presentation definitions associated with a second recycling service provider.

A set of service presentation definitions may define the visual appearance of a graphical user interface within which recycling information regarding the corresponding recycling services may be presented on mobile devices 104. Such definitions may include an arrangement (e.g. a layout, a compilation order) for presenting recycling information regarding the one or more recycling services within the graphical user interface, one or more of colors (e.g., background, font colors) associated with the graphical user interface, one or more font types/styles of the graphical user interface, one or more images (e.g., logo images identifying the recycling service providers), one or more videos, specifications specifying for frame characteristics of the graphical user interface (e.g., thickness, color, 3D effect of the frame), and/or any other definitions for the visual appearance of the graphical user interface within which the recycling information regarding recycling services is presented.

By way of non-limiting example, a first set of service presentation definitions may be associated with a first geolocation (for instance, municipality A), while a second set of service presentation definitions may be associated with another geolocation (for instance, municipality B). In this example, the first set of service presentation definitions may be different from the second set of service presentation definitions in terms of background color, frame color, logo images (for example, municipality A may be associated with an image representing its city logo and municipality B may be associated with an image representing its city logo), font size, font type, font style, layout of the recycling information, menu designs for accessing the recycling information, and/or any other aspects for presenting recycling information regarding recycling services available at municipality A and municipality B respectively. For instance, the recycling information regarding municipality A and municipality B may include rewards programs provided to residents in municipalities A and B to encourage the residents of both municipalities to recycle plastics. In this instance, the first set of service presentation definitions may define how the rewards programs in municipality A may be presented on mobile devices associated with the residents in municipality A (e.g., font color, access menu, layout of information regarding the rewards programs and/or any other presentation information for presenting the rewards programs in municipality A), By comparison, the second set of service presentation definitions associated with municipality B may define the presentation of the rewards programs available to residents of municipality B differently from the presentation of the rewards programs to residents of municipality A. This may create for a given user of system 100 a sense that different recycling services, programs, rewards, incentives, policies and/or other items are available at different locations through visual cues.

FIG. 6 illustrates one example of a set of service presentation definitions for the visual appearance of the graphical user interface presenting recycling information regarding a given recycling service available at a given location. As illustrated in FIG. 6, the set of presentation definitions associated with a given geolocation as managed by the service presentation definition component 116 may be transmitted to a mobile device 104 along with the recycling information regarding one or more recycling services available at the given location such as the recycling information 302 illustrated in FIG. 3 for presentation on mobile device 104. This may create a look-and-feel identifying the recycling service provider and/or service location on the mobile device 104 when presenting the recycling information 302.

In some examples, the service presentation definitions may include definitions that define audio presentation of recycling information 302 on the mobile device 104. In those examples, the system 100 may be configured to receive calls (cellular, Wi-Fi, or other communication medium for receiving calls) from a user via the mobile device 104. As discussed below, all or some of such call receiving functionality may be provided by a device communication component on the server 102 such as the device communication component 118 illustrated in this example. In any case, in those examples, the service presentation definitions may be associated with a geolocation and may include audio presentation definitions for presenting the recycling information regarding one or more recycling services available at the associated geolocation. Such audio presentation definitions may define voice style, tone, language, accent, levels and content of access menus, greeting style, speech pattern, and any other audio presentation definitions for presenting the recycling information in audio on the mobile device 104.

Returning to FIG. 1, the device communication component 118 may be configured to facilitate communications between server 102 and individual mobile devices 104. Operations by device communication component 118 may involve receiving communication requests from the individual mobile devices 104, receiving location information from the mobile devices 104, transmitting information such as recycling information 302 and service presentation definition information 602 to the individual mobile devices 104 for presentation, receiving user input (e.g., reminder settings, buy-back offers), and/or any other operation for facilitating communications between the server 102 and individual mobile devices 104.

In implementations, the communications facilitated by device communication component 118 may include textual, video, audio, image, multimedia, and/or any other types of communications. In some examples, the device communication component 118 may be configured to exchange communication data with a given mobile device 104 such that a multimedia presentation of recycling information 302 may be effectuated on a given mobile device 104 (for example, in a mobile app). In some examples, the communication between a given mobile device 104 and server 102 may be textual such that the user associated with the mobile device 104 can send text message(s) including information indicating the user's location, and the server 102 can respond with text messages to the given mobile device 104 including recycling information 302. In other examples, the communication facilitated by the device communication component 118 may be audio such that a user can initiate a call (via cellular, WI-FI, and/or any other communication medium) to the server 102, and the server 102 can respond with an audio presentation of the recycling information 302 to the given mobile device 104.

In any type of communications facilitated by the device communication component 118, the device communication component 118 may receive location information from a given mobile device 104, indicating a location that is of interest to a user associated with the given mobile device 104. As used herein, such a location is referred to as a “user location”. FIG. 4 illustrates one example in which the server 102 may receive such location information (e.g., via the device communication component 118 from the mobile device 104). I will be described with reference to FIGS. 1-3. It should be understood that FIG. 4 is not intended to be limiting. Other methods of receiving location information are contemplated. For example, the GPS coordinates of user location may be automatically transmitted to the server 102 via device communication component 118. In some examples, the device communication component 118 may employ automatic location information (ALI) transmitted along with a communication request by the mobile device 104 (e.g. through a cellular call). In any case, in some examples, the received location information may be used to a location associated with the user as shown in FIG. 2. In those examples, the received location information may be forwarded to the user component 112. In some examples, as shown in this example, the received location information may indicate a recycling service retrieval request from the user such that the user desires to acquire recycling information regarding recycling service(s) available at the location indicated by the received location information. As shown in FIG. 4, in response to receiving the location information in those examples, the server 102 may examine the recycling information 302 to determine which recycling service(s) is available at a geolocation (e.g., a city where the user resides). For example, such an examination by the server 102 may determine that a particular user location falls within a geolocation in which one or more recycling services are available because that geolocation includes one or more recycling services. As illustrated in this example, based on the result of such an examination, the server 102 may return a result set 402 indicating one or more recycling services are available at the location included in the received location information.

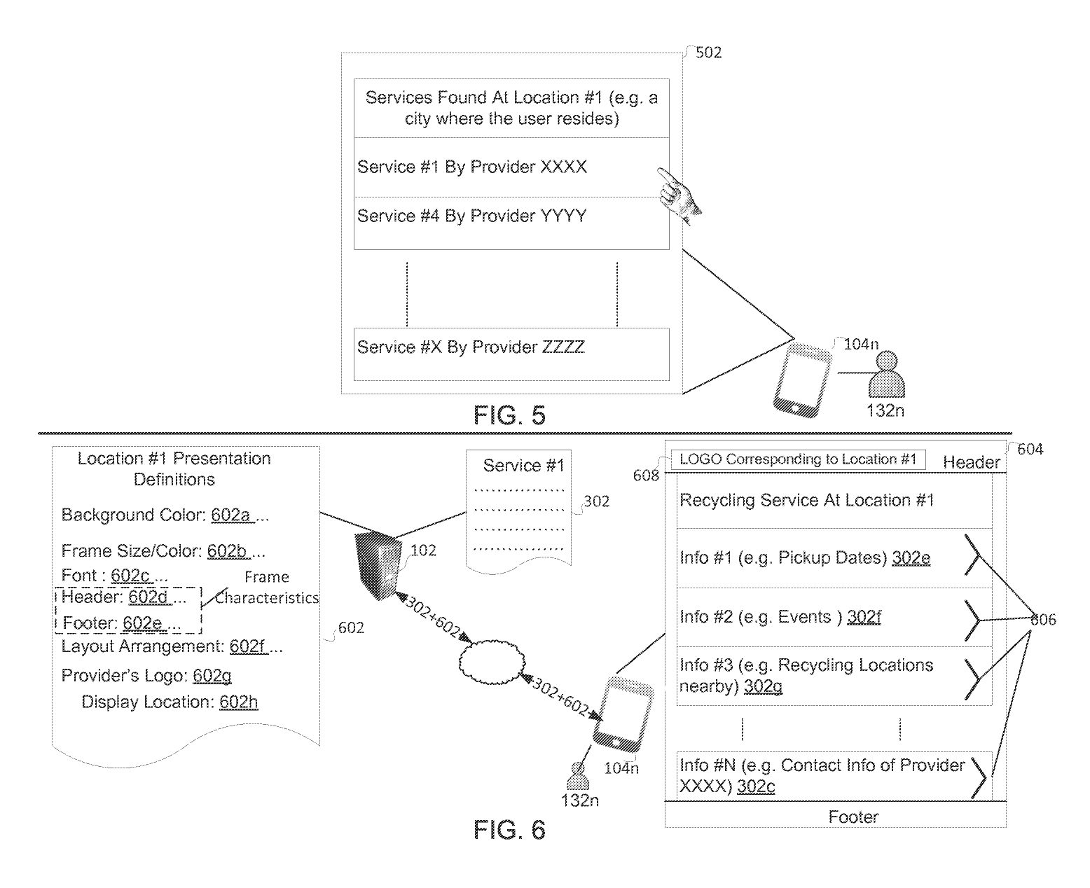

FIG. 5 illustrates one example of presenting one or more recycling services available at a user's location on the mobile device 104. As shown, interface 502 may present a set of one or more recycling services available at a geolocation corresponding to the user's location. Field controls on touch sensitive surfaces may be employed in the interface 502 to enable the user to select a desired recycling service provided by a given recycling service provider. In this example, the user may select service #1 provided by recycling service provider “XXXX”.

The presentation component 120 may be configured to effectuate presentation of recycling information regarding one or more recycling services available at a given geolocation (location #1, in this example) on the mobile device 104 in accordance with a set of one or more service presentation definitions associated with the given geolocation as managed by the service presentation definition component 116. For example, the presentation component 120 may effectuate such a presentation in response to receiving a user location corresponding to the geolocation (location #1, in this example), e.g., via the device communication component 118. To achieve this, the presentation component 120 may be configured to retrieve the recycling information 302 and the associated service presentation definitions 602 based on recycling service(s) available at the geolocation corresponding to the user location. In some examples, the presentation component 120 may effectuate transmission of the appropriate recycling information 302 and service presentation definition(s) 602 to the mobile device 104 associated with the user via the device communication component 118. This is illustrated in FIGS. 6-8.

As shown in FIG. 6, various categories of recycling information 302 may be presented on the mobile device 104 in a main interface 604 in accordance with the associated presentation definition(s) 602. For example, as shown in FIG. 6 and as described above, information such as pickup date and time, upcoming events, nearby recycling locations, contact information of the recycling service provider, and/or any other recycling information regarding the recycling service available at a geolocation corresponding to the user's location may be presented in the main interface 604. As shown in this example, a logo 608 (e.g., a city logo image) corresponding to the geolocation may be displayed in the interface 604 in accordance with the service presentation definitions 602. This may create a look-and-feel that brands the geolocation. As also shown, field controls 606 may be provided in the interface 604 to enable users to view further details about the recycling information 302 presented in the main interface 604.

FIG. 7 illustrates one example of presenting information on a mobile device regarding the pickup date and time of a given recycling service at a geolocation corresponding to a user's location. As shown in this example, an information window 702 may be activated and presented on the mobile device 104 in response to a user selecting (e.g., by finger tap) the pickup information in the interface 604 on the mobile device 104. As shown, the window 702 may present pickup information specific to the service location of the recycling service selected by the user. As also shown in this example, a field control 704 may be provided in the window 702 to enable the user to set a reminder reminding the user to take out waste for recycling on or before the date and time of the pickup shown in window 702. As will be described, the reminder functionality shown in window 708 may be accessed through the notification component 122. As also shown in this example, a control 706 may be provided to enable the user to view further details regarding one or more materials accepted by the recycling service provider selected by the user in providing the recycling service at the user location. As shown in this example, the control 706 may activate a window 710 within which materials accepted may be specified. As also shown, window 710 may present information indicating materials that may not be accepted by the recycling service provider through the recycling service at the user's location.

FIG. 8 illustrates an example of presenting on a mobile device information regarding upcoming events related to a recycling service available at a given geolocation. As shown, in response to a user selecting (e.g., by finger tap) “the upcoming event” in the interface 604, a window 802 may be presented on the mobile device 104. As illustrated, the upcoming events presented in the window 802 may indicate one or more events 804 (special services or no services, for example) are scheduled during a predetermined period (e.g., within the next 3 months). As shown, a control 808 corresponding to an individual event may be provided to enable a user to set a reminder of the individual event.

It should be understood that, although FIGS. 6-8 illustrate the presentation of recycling information in visual format by the presentation component 120, this is not intended to be limiting. As should be clear, the presentation of recycling information by the presentation component 120 may be in audio. For example, the presentation of recycling information illustrated in FIGS. 6-8 may be in audio format such that a user may receive the recycling information by sending an audio presentation request (e.g., initiating a call to the server 102, as described above). In that example, the recycling information presented to the user may be in accordance with service presentation definition(s) that define the audio presentation of the recycling information as described above.

Returning to FIG. 1, the processor 108 in the server 102 may optionally include a notification component 122 configured to receive, from a mobile device, information for setting a reminder that reminds to the user associated with the mobile device 104 to receive recycling services on a set of one or more dates, and configured to effectuate the reminder on the mobile device 104 on that set of the one or more dates. To achieve this, the notification component 122 may be configured to employ the device communication component 118 for receiving a reminder date or reminder dates along with the information for the user to be reminded about. As shown in FIGS. 7 and 8, the user may input such information via the controls in 708 or 808. For example, the user may, via the controls 708, set a reminder to remind the user to take out his/her household waste every Monday at 9 pm for waste collection every Tuesday morning. Upon receiving such information, the notification component 122 may schedule such a reminder for the user in connection with the user ID (e.g., as managed by the user component 112). However, this is not necessarily the only case. In some other examples, reminder service provided by the mobile device 104 may be employed for setting such reminders. In those examples, the interfaces described in FIGS. 7 and/or 8 may be configured to communicate with the reminding services provided by the mobile devices 104.

In some examples, the notification component 122 may be configured to generate notifications for presentation on a mobile device notifying the user about updates in recycling service information regarding the recycling service(s) available at the user's location. For example, the recycling service information regarding dates for weekly curbside waste pickup may be updated at the geolocation corresponding to the user's location. In that example, the notification component 122 may generate a notification of such an update to the user, and the notification may be pushed to the mobile device 104 associated with the user.

In some examples, the processor 108 on the server 102 may optionally comprise the recycling location component 124 configured to retrieve one or more recycling locations near the user's location. For example, based on the user's location, one or more drop-off sites may be retrieved by the recycling location component 124. To achieve this, the recycling location component 124 may employ device communication component 118 for receiving information from users indicating the users' locations. In some examples, the recycling location component 124 may optionally receive information indicating one or more materials to be recycled by the user. In response to receiving such information, the recycling location component 124 may examine recycling service information 302 at the user's location and determine which recycling locations may have capacity to recycle the materials requested by the user. In some examples, the recycling location component 124 may overlay the recycling locations that have such capacities on a digital map and employ the presentation component 120 to effectuate the presentation of the overlaid digital map on the mobile device 104.

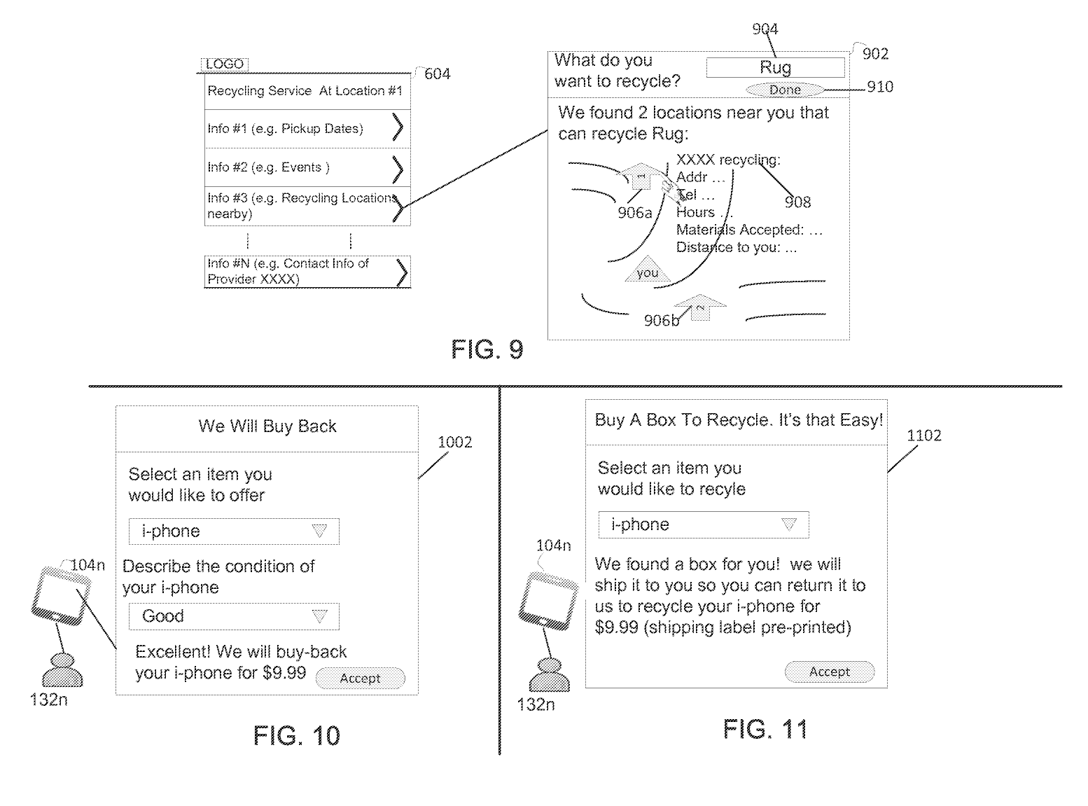

FIG. 9 illustrates one example of presenting recycling locations near a user location on a mobile device. As shown in this example, in response to the user selecting “recycling locations nearby” in the interface 604, a window 902 may be activated. As shown, the window 902 may include an input box 904 enabling the user to input a type of material that the user desires to recycle. As shown in this example, the input box 904 enables the user to find recycling locations near the user's location that have the capability to recycle rugs. However, the input illustrated in input box 904 is not intended to be limiting. Other examples of input are contemplated. For example, the user may input, via the input box 904, a particular type of recycling location of interest to the user (e.g., drop-off sites for household waste, e-waste collection stations, or retail stores that collect plastic bottles, just to name few). In any case, a control 910 may be provided for the user to instruct the system 100 to search for recycling location(s) near the user based on the input provided through input box 904. As shown, a digital map may be displayed in the window 902 with recycling locations 906 (that can recycle rugs, in this example) overlaid on the digital map showing their relative positions with respect to the user's location. As also shown, the window 902 may be configured to present information 908 regarding the recycling locations 906 when selected by (e.g., finger tap) the user.

In some examples, the processor 108 on the server 102 may optionally comprise the offer component configured to facilitate a user associated with a mobile device to offer, via the mobile device, an item in exchange for consideration from a recycling service provider selected by the user. To achieve this, the offer component 126 may employ device communication component 118 for receiving information indicating one or more items a user wishes to sell to the recycling service provider. In some examples, the user may be enabled to submit prices at which the user wishes to sell one or more items. However, in some other examples, the prices for such items may be determined by the server 102 based on information predetermined by the recycling service provider. In any case, the offer component 126 may transmit such offer information received from the user to computers 134 associated with the recycling service providers for processing.

In some examples, the offer component 126 may be configured to facilitate presenting offers provided by the recycling service provider to users on a mobile device. Such offers may include, but not limited to, offers for buying back used products from the user (e.g., used smart phones, computers, TVs and so on), offers to encourage the user to recycle waste at the recycling service provider's facilities (e.g., discounts for recycling e-waste or increased payback for recycling plastic bottles and/or tin cans), and/or any other types of offers from recycling service providers.

In some examples, the offer component 126 may be configured to present offers for users to purchase from the recycling service provider a container in which the user can mail one or more materials to be recycled to the recycling service provider for recycling. For example, an offer of a carton box at $19.99 may be presented on the mobile device 104 such that the user may purchase the carton box, which will be shipped to the user, so that the user may place a used i-phone in the carton box and mail the carton box (with shipping label and fees pre-printed and prepaid by the recycling service provider) back to the recycling service provider for recycling.

FIG. 10 illustrates one example of presenting an interface on a mobile device enabling a user associated with the mobile device 104 to offer items in exchange for consideration from a recycling service provider. As shown in this example, the interface 1002 may be presented on the mobile device 104 to enable the user to offer an item such as a used i-phone to a recycling service provider at a price predetermined by the recycling service provider.

FIG. 11 illustrates one example of presenting an interface on a mobile device enabling a user associated with the mobile device 104 to buy a container for recycling an item. As shown in this example, the interface 1102 may be presented on the mobile device 104 such that the user 132 may purchase the box for a fee that covers the shipping cost and/or recycling cost for recycling the item by the user.

In some examples, the processor 108 on the server 102 may optionally comprise a drop-off confirmation component 128 configured to receive, from a mobile device, drop-off information indicating that one or more materials to be recycled has been dropped off at a recycling location by the user associated with the mobile device 104, transmit the received drop-off information to a computing platform associated with the recycling location for confirmation by the recycling location, receive from the computing platform associated with the recycling location information confirming the receipt of drop-off information; and effectuate the presentation of a confirmation of the drop-off information on the mobile device 104. To achieve this, the drop-off confirmation component 128 may employ the device communication component 118 for receiving information indicating that waste has been dropped off at a recycling location operated by a recycling service provider. Such information may include information indicating types of materials dropped off, amounts (e.g., weight or item count) of materials dropped off by the user, time and date of the drop-off, location of the drop-off, and/or any other types of information. In response to receiving such information from the mobile device 104, the drop-off confirmation component 128 may transmit the information to a computer 134 associated with the recycling service provider indicated by the information received from the mobile device 104. In some instances, the drop-off confirmation component 128 may be configured to receive confirmation of the drop-off information from the computer 134 associated with the recycling service provider, and effectuate presentation, e.g., via the presentation component 120, of the confirmation on the mobile device 104 so that the user is informed that the drop-off materials have been received by the recycling service provider.

In some examples, the processor 108 on the server 102 may optionally comprise the carbon print calculation component 130 to calculate carbon footprint requested by a user. The calculation by the carbon print calculation component 130 may be based on one or more materials submitted by the user, e.g., via the device communication component 118. By way of non-limiting example, the user may request calculating carbon prints for a few used items the user wishes to recycle. In some examples, the calculation by the carbon print calculation component 130 may be based on materials that have been recycled by the user in the past. Still, by way of non-limiting example, the user may request to calculate carbon prints of materials that have been recycled by the user within the past month, 3 months, 6 months, and so on. In any case, to achieve such calculations, the carbon print calculation component 130 may acquire information indicating types and amounts of materials as the input of the calculation. A formula or formulas for calculating carbon footprint based on such inputs may be preconfigured with the carbon print calculation component 130 for calculating the carbon footprint upon the user's request.

Referring back to FIG. 1, the server 102, mobile devices 104, electronic storage 110 and/or external resources 106 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server 102, client computing platforms 104, servers 108, 110 and/or external resources 106 may be operatively linked via some other communication media.

A given mobile device 104 may include one or more processors configured to execute computer program modules. The computer program modules may be configured to enable an expert or user associated with the given mobile device 104 to interface with server 102 and/or provide other functionality attributed herein to mobile device 104. By way of non-limiting example, the given mobile device 104 may include one or more of a smartphone, tablet, a laptop computer, a handheld computer, a NetBook, a cellular phone, and/or other computing platforms.

External resources 106 may include sources, hosts, and providers of information exchanges outside of servers 102, external entities participating with severs 102 and/or 104, and/or other resources. The external resources 106 may include servers associated with third part entities with respect to the recycler, e.g., freight services, commodity brokers, regulatory agencies, and/or other third party entities. It should be appreciated that the data provided by the external resource 106 is not necessarily limited to one layer of data in direct relationship with the recycler; data clustering is also contemplated. In some implementations, some or all of the functionality attributed herein to external resources 106 may be provided by resources included in servers 102.

Electronic storages 110 may comprise non-transitory storage media that electronically stores information. The electronic storage media of electronic storage 110 may include one or both of system storage that is provided integrally (i.e., substantially non-removable) with servers 102 and/or removable storage that is removably connectable to servers 102 via, for example, a port (e.g., a USB port, a firewire port, etc.) or a drive (e.g., a disk drive, etc.). Electronic storages 110 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storages 110 may include one or more virtual storage resources (e.g., cloud storage, a virtual private network, and/or other virtual storage resources). Electronic storages 110 may store software algorithms, information determined by processors 116, information received from servers 102, information received from client computing platforms 104, external resource 106 and/or other information that enables servers 102 to function as described herein.

Processor 108 is configured to provide information processing capabilities in server 102 respectively. As such, Processors 108 may include one or more of a digital processor, an analog processor, a digital circuit designed to process information, an analog circuit designed to process information, a state machine, and/or other mechanisms for electronically processing information. Although processor x is shown in FIG. 1 as a single entity, this is for illustrative purposes only. In some implementations, Processors 116 may include a plurality of processing units. These processing units may be physically located within the same device, or Processors 116 may represent processing functionality of a plurality of devices operating in coordination. The processors 108 may be configured to execute modules 112, 114, 116, 118, 120, 122, 124, 126, 128, 130. Processors 116 may be configured to execute modules 112, 114, 116, 118, 120, 122, 124, 126, 128, 130 by software; hardware; firmware; some combination of software, hardware, and/or firmware; and/or other mechanisms for configuring processing capabilities on processors 108. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 112, 114, 116, 118, 120, 122, 124, 126, 128, 130 are illustrated in FIG. 1 as being implemented within a single processing unit, in implementations in which processors 108 includes multiple processing units, one or more of modules 112, 114, 116, 118, 120, 122, 124, 126, 128, 130 may be implemented remotely from the other modules. The description of the functionality provided by the different modules 112, 114, 116, 118, 120, 122, 124, 126, 128, 130 described below is for illustrative purposes, and is not intended to be limiting, as any of modules 112, 114, 116, 118, 120, 122, 124, 126, 128, 130 may provide more or less functionality than is described. For example, one or more of modules 112, 114, 116, 118, 120, 122, 124, 126, 128, 130 may be eliminated, and some or all of its functionality may be provided by other ones of modules 112, 114, 116, 118, 120, 122, 124, 126, 128, 130. As another example, processors 108 may be configured to execute one or more additional modules that may perform some or all of the functionality attributed below to one of modules 112, 114, 116, 118, 120, 122, 124, 126, 128, 130.

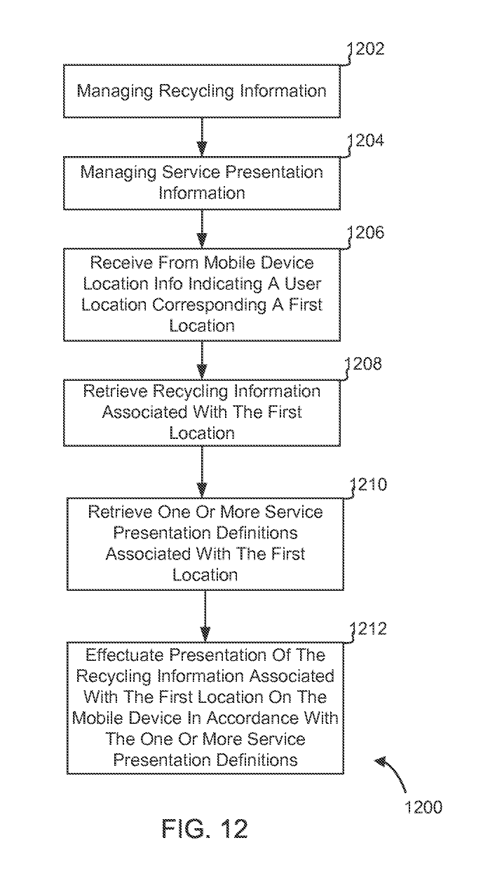

FIG. 12 illustrates an exemplary method for facilitating presentation of localized information on a mobile device in accordance with the disclosure. The operations of method 1200 presented below are intended to be illustrative. In some embodiments, method 1200 may be accomplished with one or more additional operations not described, and/or without one or more of the operations discussed. Additionally, the order in which the operations of method 1200 illustrated in FIG. 3 and described below is not intended to be limiting.

In some embodiments, method 1200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 1200 in response to instructions stored electronically on an electronic storage medium. The one or more processing devices may include one or more devices configured through hardware, firmware, and/or software to be specifically designed for execution of one or more of the operations of method 1200.

At operation 1202, recycling information regarding recycling service(s) available at corresponding service locations may be managed. Examples of recycling services indicated by the recycling information managed by operation 1202 may include household waste collection, recycling and disposal service, e-waste collection and recycling service, automotive disposal, construction materials disposal, metal and glasses disposal, buy-back service, special item handling services (e.g., chemical waste, medical waste), and any other types of recycling services. The information regarding a given recycling service available at a given service location as managed by operation 1202 may include, but not limited to, identifying information identifying the recycling service provider(s) providing the given recycling service, location information indicating where the given recycling service is provided, collection information indicating, for example, pickup date and time of the given recycling service, upcoming events associated with the given recycling service, material accepted by the given recycling service, service location(s), reward programs, incentive information associated with the given recycling service, drop-off sites, contact information of the given recycling service provider, and/or any other recycling information regarding the given recycling service. In some implementations, operation 1202 may be performed by a recycling service information component the same as or similar to recycling service information component 114 (shown in FIG. 1 and described herein).

At operation 1204, service presentation definitions for presenting recycling information managed by operation 1202 may be managed. The service presentation definitions managed by operation 1204 may be differentiated from geolocations to geolocations. In some examples, the service presentation definitions may be further differentiated based on different service providers within a given geolocation. A set of service presentation definitions may define visual appearance of a graphical user interface within which recycling information regarding the corresponding recycling services may be presented on mobile devices associated with users. The definitions may include an arrangement in presenting the information regarding a given recycling service within the graphical user interface, one or more of colors associated with the graphical user interface, one or more font types/styles of the graphical user interface, one or more images, one or more videos, specifications of frame characteristics of the graphical user interface, and/or any other definitions defining visual appearance of the graphical user interface within which the recycling information regarding recycling services is presented. In some examples, the service presentation definitions may include definitions that define audio presentation of recycling information on a mobile device associated with the user. Such audio presentation definitions may define voice style (e.g., male vs female, high pitch vs low pitch, and other voice styles), tone, language (e.g., English vs Spanish), accent, levels and content of access menus (e.g., main menus, and multiple levels of sub-menus), greeting style, speech pattern, and any other audio presentation definitions for presenting the recycling information in audio on the mobile device. In some implementations, operation 1204 may be performed by a service presentation definition component the same as or similar to service presentation definition component 116 (shown in FIG. 1 and described herein).

At operation 1206, location information indicating a user location corresponding to a first location (e.g., a geolocation) may be received from a mobile device associated with the user. Such location information may be received in operation 1206 though text messages, user voice (e.g., through a call), in-app inputs, and/or any other types of communication means from the mobile device associated with the user. In some implementations, operation 1206 may be performed by a device communication component the same as or similar to device communication component 118 (shown in FIG. 1 and described herein).

At operation 1208, recycling information regarding one or more recycling services available at the first location indicated by the location information received in operation 1206 may be retrieved. This may involve examining the recycling service information managed by operation 1202 to determine which recycling service(s) is available at the first location. Based on a result of the examination, a result set indicating one or more recycling services are available at the first location may be retrieved in operation 1208. In some implementations, operation 1208 may be performed by a presentation component the same as or similar to presentation component 120 (shown in FIG. 1 and described herein).

At operation 1210, one or more service presentation definitions associated with the first location may be retrieved. This may involve examining the service presentation definitions managed by operation 1204 to determine which service presentation definition(s) is associated with the first location. Based on a result of the examination, a result set indicating one or more service presentation definitions are available at the first location may be retrieved in operation 1210. In some implementations, operation 1210 may be performed by a presentation component the same as or similar to presentation component 120 (shown in FIG. 1 and described herein).

At operation 1212, presentation of the recycling information associated with the first location retrieved in operation 1208 may be effectuated on the mobile device in accordance with one or more service presentation definitions retrieved in operation 1212. This may involve effectuating transmission of the retrieved recycling information and service presentation definition(s) to the mobile device for presentation. In some implementations, operation 1212 may be performed by a presentation component the same as or similar to presentation component 120 (shown in FIG. 1 and described herein).

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system for facilitating presentation of localized recycling service on mobile devices associated with users, the system comprising
one or more physical processors configured by machine-readable instructions to:
manage recycling information regarding recycling services available at corresponding locations such that recycling information regarding one or more recycling services available at a first location is managed, the recycling information regarding the one or more recycling services available at the first location including information indicating one or more pickup dates, one or more recycling events, one or more reward programs, one or more incentives, and/or one or more recycling tips associated with the first location;
manage service presentation definitions for presenting the recycling information on the mobile devices, the service presentation definitions including a first service presentation definition that defines visual appearance of a graphical user interface within which recycling information regarding the one or more recycling services available at the first location is presented;
receive, from a mobile device associated with a user, location information indicating a user location corresponding to the first location; and
responsive to receiving the location information indicating the user location correspond to the first location, effectuate presentation of the recycling information regarding the one or more recycling services available at the first location on the mobile device in accordance with the first service presentation definition.

2. The system of claim 1, wherein the one or more physical processors are further configured to receive, from the mobile device, information for setting a reminder that reminds the user associated with the mobile device to receive the one or more recycling services available at the first location on a set of one or more dates, and to effectuate the reminder on the mobile device on the set of the one or more dates.

3. The system of claim 1, wherein the visual appearance of the graphical user interface within which information regarding the first recycling service provided at the first location is presented as defined by the first service presentation definition includes an arrangement in presenting the recycling information regarding the one or more recycling services available at the first location within the graphical user interface, one or more of colors, one or more fonts of the graphical user interface, one or more images, one or more videos and/or one or more visual indications identifying the first location in the graphical user interface.

4. The system of claim 1, wherein the one or more physical processors are further configured by the machine-readable instructions to receive, from the mobile device, information indicating a material to be recycled, and wherein the effectuated presentation of the information regarding the one or more recycling services available at the first location on the mobile device includes presentation of one or more recycling locations near the user location that may collect the material.

5. The system of claim 4, wherein the presentation of one or more recycling locations on the mobile device includes presenting a digital map based on the first location and overlaying the first location and the one or more recycling locations on the digital map.

6. The system of claim 4, wherein the presentation of one or more recycling locations on the mobile device includes presenting one or more materials accepted by the one or more recycling locations and/or distances from the one or more recycling stations to the user location.

7. The system of claim 1, wherein the one or more physical processors are further configured by machine-readable instructions to:
receive, from the mobile device, drop-off information indicating one or more materials to be recycled has been dropped off at a recycling location by the user associated with the mobile device;
transmit, the received drop-off information to a computing platform associated with the recycling location for confirmation;
receive, from the computing platform associated with the recycling location, information confirming the received drop-off information; and
effectuate presentation of a confirmation of the drop-off information on the mobile device.

8. The system of claim 1, wherein the one or more physical processors are further configured by machine-readable instructions to facilitate the user associated with the mobile device to offer an item in exchange for consideration from a recycling service provider.

9. The system of claim 1, wherein the one or more physical processors are further configured by machine-readable instructions to facilitate the user associated with the mobile device to calculate carbon footprint based on materials requested by the user.

10. The system of claim 1, wherein the one or more physical processors are further configured by machine-readable instructions to facilitate the user associated with the mobile device to purchase, from a recycling service provider, a container through which the user can mail one or more materials to the recycling service provider for recycling.

11. The system of claim 1, wherein the one or more physical processors are further configured to facilitate a recycling service provider to enter marketing information targeted at the user associated with the mobile device based on the recycled materials and/or recycling activities that have been engaged by the user at the first location.

12. The system of claim 1, wherein the service presentation definitions include a second service presentation definition that defines audio presentation of the recycling information regarding the one or more recycling services available at the first location and wherein the one or more processors are further configured by the machine-readable instructions to:
receive, from the mobile device associated with the user, an audio request for presenting the recycling information regarding the one or more recycling services available at the first location in audio on the mobile device; and
responsive to receiving the location information indicating the user location correspond to the first location and the audio request, effectuate presentation of the recycling information regarding the one or more recycling services available at the first location on the mobile device in accordance with the second service presentation definition.

13. A method for facilitating presentation of localized recycling service on mobile devices associated with users, the method being executed in one or more physical processors configured to execute computer program modules, the method comprising:
managing recycling information regarding recycling services available at corresponding locations such that recycling information regarding one or more recycling services available at a first location is managed, the recycling information regarding the one or more recycling services available at the first location including information indicating one or more pickup dates, one or more recycling events, one or more reward programs, one or more incentives, and/or one or more recycling tips associated with the first location;
managing service presentation definitions for presenting the recycling information on the mobile devices, the service presentation definitions including a first service presentation definition that defines visual appearance of a graphical user interface within which recycling information regarding the one or more recycling services available at the first location is presented;
receiving, from a mobile device associated with a user, location information indicating a user location corresponding to the first location; and
responsive to receiving the location information indicating the user location correspond to the first location, effectuating presentation of the recycling information regarding the one or more recycling services available at the first location on the mobile device in accordance with the first service presentation definition.

14. The method of claim 13, further comprising receiving, from the mobile device, information for setting a reminder that reminds the user associated with the mobile device to receive the one or more recycling services available at the first location on a set of one or more dates, and to effectuate the reminder on the mobile device on the set of the one or more dates.

15. The method of claim 13, wherein the visual appearance of the graphical user interface within which information regarding the first recycling service provided at the first location is presented as defined by the first service presentation definition includes an arrangement in presenting the recycling information regarding the one or more recycling services available at the first location within the graphical user interface, one or more of colors, one or more fonts of the graphical user interface, one or more images, one or more videos and/or one or more visual indications identifying the first location in the graphical user interface.

16. The method of claim 13, further comprising receiving, from the mobile device, information indicating a material to be recycled, and wherein the effectuated presentation of the information regarding the one or more recycling services available at the first location on the mobile device includes presentation of one or more recycling locations near the user location that may collect the material.

17. The method of claim 16, wherein the presentation of one or more recycling locations on the mobile device includes presenting a digital map based on the first location and overlaying the first location and the one or more recycling locations on the digital map.

18. The method of claim 16, wherein the presentation of one or more recycling locations on the mobile device includes presenting one or more materials accepted by the one or more recycling locations and/or distances from the one or more recycling stations to the user location.

19. The method of claim 13, further comprising:
receiving, from the mobile device, drop-off information indicating one or more materials to be recycled has been dropped off at a recycling location by the user associated with the mobile device;
transmitting, the received drop-off information to a computing platform associated with the recycling location for confirmation;
receiving, from the computing platform associated with the recycling location, information confirming the received drop-off information; and
effectuating presentation of a confirmation of the drop-off information on the mobile device.

20. The method of claim 13, further comprising facilitating the user associated with the mobile device to offer an item in exchange for consideration from a recycling service provider.

21. The method of claim 13, further comprising facilitating the user associated with the mobile device to calculate carbon footprint based on materials requested by the user.

22. The method of claim 13, further comprising facilitating the user associated with the mobile device to purchase, from a recycling service provider, a container through which the user can mail one or more materials to the recycling service provider for recycling.

23. The method of claim 13, further comprising facilitating a recycling service provider to enter marketing information targeted at the user associated with the mobile device based on the recycled materials and/or recycling activities that have been engaged by the user at the first location.

24. The method of claim 13, wherein the service presentation definitions include a second service presentation definition that defines audio presentation of the recycling information regarding the one or more recycling services available at the first location and the method further comprising:
receiving, from the mobile device associated with the user, an audio request to for presenting the recycling information regarding the one or more recycling services available at the first location in audio on the mobile device; and
responsive to receiving the location information indicating the user location correspond to the first location and the audio request, effectuating presentation of the recycling information regarding the one or more recycling services available at the first location on the mobile device in accordance with the second service presentation definition.
